(19) United States
(12) Patent Application Publication
(10) Pub. No.: US 2009/0077779 A1
(43) Pub. Date: Mar. 26, 2009

(54) Memorial objects incorporating cremation ash

(76) Inventors: Kurt Zimmerman, Fredericksberg, VA (US); Lawrence Edward Mervine, Fredericksburg, VA (US)

Correspondence Address: Dennis H. Lambert, 7000 View Park Drive, Burke, VA, 22015, US

(21) Appl. No.: 11/902,640

(22) Filed: Sep. 24, 2007

(51) Int. Cl. A61G 17/00; A61G 17/08

(52) U.S. Cl. 27/1; 110/341

(57) ABSTRACT

A memorial object cast in a mold and formed of a concrete mix having up to about 50% sand, up to about 25% aggregate, up to about 25% cement, and water. In one embodiment of the invention cremation ash is incorporated in the mix up to about 60% of the mix, with the percentage of at least one of the other ingredients, preferably sand and/or aggregate, being reduced corresponding to the amount of cremation ash added. In another embodiment, a cavity is formed in the object for receiving and holding a separate container holding cremation ashes. Various additives can be added to the mix, either alone or in combination, including an accelerator, an air entrainer, a plasticizer, and glass fibers. One or more of a motion detector, voice-activated recording, water effects and/or an illumination device can be mounted in the object.

This application claims the benefit of prior copending application Ser. No. 11/611,090, filed Dec. 14, 2006.

### TECHNICAL FIELD

This invention relates in general to memorial objects. More particularly, the invention relates to memorial objects cast from a cementitious material and incorporating cremation ashes from a loved one or a pet.

### BACKGROUND ART

The remains of a deceased person are traditionally either prepared for burial and then interred in a grave or tomb, or the remains are cremated and the ashes usually placed in an urn for delivery to the survivors of the deceased. Approximately 7 to 10 pounds of cremation residue are produced upon cremation of the average adult. Occasionally, the ashes of the deceased are scattered over a particular landscape or over a body of water, and the like, in accordance with the deceased person's wishes. Deceased pets also are commonly buried, either in pet cemeteries or on the property of the pet owner, or cremated and the ashes delivered to the pet owner.

Buried remains are in a fixed location, i.e., in a cemetery, and in the case of a pet sometimes on the property of the pet owner. At one time, when persons tended to live in one area all their lives, it was convenient for survivors of the deceased person or the owners of a deceased pet to visit the grave site. However, society is much more transient today, and persons frequently move to other locales, many times to different parts of the country, making it difficult to visit the grave site.

A memorial in the form of a headstone or statuary, for example, typically made of granite or marble, normally is placed at a gravesite. The memorial typically carries information relevant to the deceased and may also contain a special epithet or some other information or design pertinent to the deceased. When viewed, the memorial can bring comfort or inspiration to the survivors. However, for the reasons noted above these memorials may not be convenient for viewing.

Urns containing the ashes of a deceased person or pet are portable and can be taken along when the person having custody of the urn moves to another locale, but urns sometimes become lost or misplaced, especially during moves, or the contents may be accidentally spilled if the urn is tipped over or broken. Moreover, due to their nature the placement and storage of urns is somewhat limited.

In an effort to provide an alternate means of memorializing a deceased person or a pet, and to avoid at least some of the above-noted shortcomings of fixed memorials or of placing cremation ash in an urn, various types of memorial structures incorporating cremation ash are disclosed in the prior art, including that shown in U.S. Pat. No. 1,640,680, wherein cremation ashes are incorporated in an article of manufacture such as a clay tile or plaque that may then be placed in a location having some significance to the deceased. This patent mentions that articles other than plaques can be made, and suitable carrying materials other than clay can be used, but none are specifically named or described.

U.S. Pat. No. 5,016,330 discloses a memorial product especially intended for deceased pets, wherein cremation ash from the deceased pet is incorporated into a ceramic, plaster, porcelain, concrete or plastic moldable material and then used for making shaped objects such as statuary, including yard statuary. An example is given of ingredients and their proportions to produce a wet ceramic mixture, and ingredients but no proportions for making a porcelain product or for making a plaster composition.

U.S. Pat. No. 6,170,136 describes a system and method for incorporating cremation ash in an essentially two-dimensional work of art. In one form of the invention, a partially completed artistic rendering is applied to a canvas or other flat surface and an adhesive substrate applied to the surface, followed by application of cremation ash in a desired pattern. In another form of the invention, a liquid plastic substance is poured into a mold or container. Mementos such as flowers, photos or personal items are then arranged in the liquid plastic material, followed by application of cremation ash to the surface.

U.S. Pat. No. 6,189,188 discloses a system of memorialization of human cremains, wherein cremation ashes are placed in a cementitious material that is then molded into a shape that interlocks with like products and is used to form an artificial reef. The ashes are combined with cementitious material and encapsulated in pockets in a shaped block of cementitious material so that the cremains are not exposed to the outer surface of the block and thus are not exposed to the deleterious effects of surrounding sea water.

U.S. Pat. No. 6,200,507 discloses a method for making a memorial that incorporates cremation ash, wherein the ash is combined with a resin material that is poured into a statuary urn or shell that can have any desired shape and can have various surface finishes.

U.S. Pat. Nos. 6,382,111 and 6,615,463 disclose a method for solidifying cremation residue, wherein cremation ash is calcined and then mixed with any of various materials, including glass, ceramics, clay, an organic polymer matrix, a metal matrix, plaster, paint, or cementitious material, and formed into a solid object having a desired shape. The patent notes that a plasticizer such as melamine or naphthalene can be used with water to improve workability when the ash is mixed in a cementitious material. For making an object of cementitious material, an example of the ingredients and proportions used are given only for plaster of Paris. See example 6 at columns 8 and 9. The example describes samples using either calcined or non-calcined ash, with the observation that the ash can be present in an amount of more than 61 wt % of the final mix, but it is noted that cementing action is insufficient at 88 wt %.

There remains a need for a memorial object that incorporates the cremation ashes of a loved one, or a pet, wherein the memorial is relatively inexpensive and simple to make, is durable for indoor or outdoor use, may be kept with the survivor or survivors of the deceased, and which may be given any desired size, shape, theme or color. More specifically, there is need for a memorial object made from cast or molded concrete having cremation ash incorporated therein and preferably one or more additives to obtain a desired surface finish and to improve flowability, strength, and durability.

### DISCLOSURE OF THE INVENTION

The present invention comprises a memorial object cast from concrete, with cremation ashes incorporated therein. It should be understood that as used herein cremation ash is not limited to just ash as that term may be commonly understood, but is intended to cover cremation residue, which includes bone particles as well as ash. In one form of the invention the ashes are mixed with the concrete, and in another form a recess or compartment is formed in the object for receiving and storing the ashes, which may simply be placed in the compartment or contained in a separate container that is then placed in the compartment. The object may be given any desired size and shape and can function as indoor or outdoor statuary, or as a fountain or part of a fountain, or as a planter or part of a planter, or as a pedestal on which other objects can be supported, and the like. In preferred embodiments additives are placed in the concrete to enhance desired physical and chemical properties such as, e.g., flowability, surface finish, strength, and durability. Colorants may be added to the concrete mix during forming of the object, and/or coated on the surface of the object after it is made. A sealant coating may also be applied to the surface of the object to improve its durability, especially when the object is to be placed outdoors.

The basic mix used in making a memorial object out of cast concrete in accordance with the invention comprises light masonry sand, aggregate, cement, water, and the cremation remains. This mixture is placed in a mold of desired size and shape and permitted to cure to form the desired memorial object. A plasticizer may be added to reduce the amount of water required in the mix to properly hydrate the mix. The plasticizer will also improve the flowability of the mix, advantageous when more intricate designs are being cast. An accelerator may be added to shorten the setting time of the concrete, and glass fibers may be added to improve strength and durability. An air entraining admixture may be added to provide freeze-thaw resistance, yield control and finishability performance. Finish quality and durability may also be enhanced by adding Metakaolin or Fly Ash. Various colorants may be added to the mix and/or applied to the surface as a decorative coating. A sealant coating may be applied to the surface of the cast object to make it more resistant to deterioration from environmental conditions.

More specifically, the formulation of the basic mix in making a memorial object from cast concrete in accordance with the invention comprises up to approximately 50%, by volume, of sand, up to approximately 25% aggregate, up to approximately 25% cement, and up to about 25% cremation ash. Typically, about 1 pound of cremation ash is used per 20 pounds of cement, sand and aggregate. Up to about 60% of the mix, by volume, of ashes can be used in making the objects, depending upon the physical and chemical properties desired. In general, the percentage of one ingredient would be reduced correspondingly to an increase in another ingredient, so that the percentages of all the basic ingredients used in the mix add up to 100%. For example, the percentage of sand would be reduced correspondingly to the percentage of cremation ash added to the mix. Also, the use of more sand enables the use of less aggregate, and vice versa. The use of more sand and less aggregate generally results in a stiffer mix. Approximately 6.5 ounces of water is added for every pound of cement in the basic mix, although the amount of water can be varied to suit ambient conditions and to achieve a desired result. As discussed below, the amount of water can be reduced by up to about 40% if a plasticizer is added. The following additional additives can be added to the mix without requiring adjustment of the amount of basic ingredients, except as noted.

A preferred construction uses Type III white cement and a ⅜ inch aggregate, such as pea gravel. If greater flowability of the mix is desired, as in making objects having more intricate designs, 1 to 6 ounces of plasticizer can be added for each pound of cement used. Use of a plasticizer can also reduce by up to about 40% the amount of water required to achieve a particular flowability, depending upon ambient conditions and the amount and type of plasticizer used. A suitable plasticizer can be selected from ADVA® 190 (a polycarboxylate-based high-range water-reducing low viscosity liquid admixture), ADVA® CAST 530 (a high efficiency polycarboxylate superplasticizer designed to produce super fluid self-consolidating concrete without segregation, and to achieve high early compressive strength), or EXP 950 (a high efficiency, low addition rate polycarboxylate-based high-range water reducer designed for ready-mix application for the production of a wide range of concrete mixes, from conventional to self-consolidating concrete, designed to impart extreme workability without segregation to the concrete), all by Grace Construction Products of Cambridge, Mass., or Slick Pak, available from Fritz-Pak Corporation of Dallas, Tex.

Glass fiber can be added at the rate of about 0.5 to 1.0 ounce of fiber per cubic foot of the total mix to add strength to the object. The glass fibers preferably have a length of from about ¼ inch up to about 2 inches, and any fiber can be used as long as it has a scaffolding effect, although polypropylene does not produce entirely satisfactory results.

An amount of Metakaolin or fly ash up to about 20% of the amount of cement used can be added to improve finish quality and durability. When these ingredients are added, the amount of cement can be reduced by a like amount, but this is not necessary.

An accelerator can be added at the rate of from about 8 ounces up to about 40 ounces per about 100 pounds of cement to shorten the setting time. Suitable accelerators can comprise Daraccel® (a liquid admixture containing calcium chloride, formulated to provide faster set acceleration and increased early strength development of concrete—a chloride accelerator for use in molds not containing metal), or Daraset® 200 or Daraset® 400 (both non-corrosive, non-chloride admixtures that accelerate cement hydration, resulting in shortened setting times and increased early compressive and flexural strengths—non-chloride accelerators for use in molds containing metal), all available from Grace Construction Products of Cambridge, Mass.

An air entraining admixture can be added at the rate of from about 0.5 ounces up to about 2 ounces per about 110 to 120 pounds of mix to provide freeze-thaw resistance, yield control and finishability performance. Suitable air entraining admixtures can comprise Daravair® 1000 or Daravair® 1400 (both liquid admixtures that provide freeze-thaw resistance, yield control and finishability performance across the full range of concrete mix designs—for use where the purposeful entrainment of air is required by concrete specifications), available from Grace Construction Products.

Powder or liquid colors can be added to the mix as desired during the mixing process and in accordance with manufacturer's instructions to obtain a desired effect, and concrete stains and/or a protective gloss or semi-gloss sealer and finish can be applied to the surface of the cast object to enhance the appearance and durability, and/or to provide a stain resistant surface seal that provides protection from ultraviolet light and/or permits moisture vapor transmission. A suitable powder or liquid colorant can be obtained, for example, from Davis Colors of Los Angeles, Calif.; a suitable stain can be obtained, for example, from Triple-S Chemical Products, Inc. of California or Scofield Systems of Florida; and a suitable sealer can comprise, for example, AquaMix Semi-Gloss Sealer, available from Aqua Mix, Inc. of Corona, Calif.

The mold for making the memorial object can be made of any suitable material, such as plastic, wood, or metal, and can incorporate a liner as desired or necessary. For instance, to obtain a smoother surface finish and/or to produce more intricate objects the mold should be made of a plastic, such as, e.g., polyethylene, or of latex with a more rigid supporting shell such as, for example, fiberglass. The mold can be vibrated or tapped after the mix has been poured in to compact the mix and ensure uniform flow of the mix to all voids of the mold.

Motion detectors, voice-activated recordings, water effects, and/or illumination devices can be added to the memorial object to enhance the personal expression as desired or instructed by the deceased or a relative of the deceased.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a perspective view of an example of a memorial object that may be made in accordance with the invention, wherein the object comprises a pedestal.

FIG. 2 is a longitudinal sectional view of another object according to the invention, wherein the cremation ashes are dispersed uniformly throughout the object.

FIG. 3 is a longitudinal sectional view of a further object according to the invention, wherein the cremation ashes are contained in a separate container that is placed in a cavity in the object.

FIG. 4 is a longitudinal sectional view of a still further object according to the invention, wherein multiple compartments are formed in the object for receiving and storing the cremation ashes of multiple persons.

### DETAILED DESCRIPTION OF THE PREFERRED EMBODIMENTS

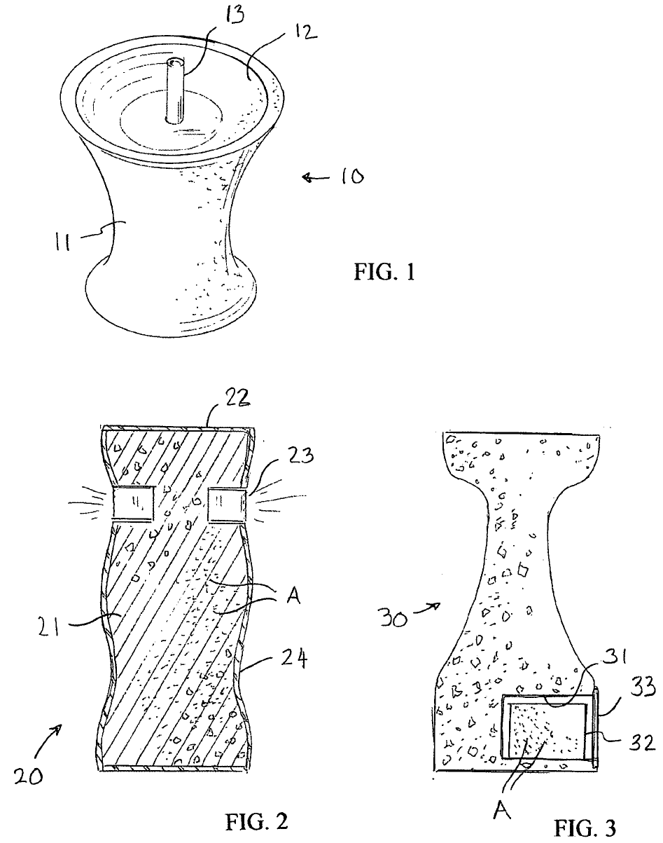

A first form of memorial object according to the invention is shown at 10 in FIG. 1, wherein the object is a fountain or bird bath, for example, having a base 11 with a desired shape, and a concave top forming a basin 12 for holding a shallow pool of water (not shown). A pipe 13 can project upwardly from the center of the bottom of the basin, if desired, so that the object can function as a fountain. A suitable water supply and recirculating pump (not shown) can be incorporated in the base in a manner known in the art to pump water up through the pipe 13, from which it will discharge and fall back into the water in the basin, making a pleasing sound. The pedestal is made by pouring a concrete mix into a mold (not shown) and permitting the concrete to set. The mix can have any suitable composition according to the invention, including but not limited to any of the specific examples described hereinafter.

Another form of memorial object made in accordance with the invention is shown at 20 in FIG. 2, wherein the object comprises a pedestal or like article of manufacture having a base 21 with a desired shape, and a flat top 22 on which items may be supported, if desired. The object may incorporate one or more of the following: motion detectors; voice activated recordings; or illumination devices, collectively indicated generically at 23. These devices are not described in detail and any of the known devices can be used for this purpose. The object is made by preparing a concrete mix according to the examples described hereinafter, with cremation ash “A” incorporated in the mix and distributed substantially uniformly throughout. The mix is poured into a mold (not shown) and permitted to set to form the object. A coating 24 of a suitable material is applied to the exterior surface of the object to provide a desired decorative appearance and/or to protect the object from the environment. The coating may comprise, for example, a protective gloss or semi-gloss sealer and finish to enhance the appearance and durability, and/or to provide a stain resistant surface seal that provides protection from ultraviolet light and/or permits moisture vapor transmission. Suitable sealers and finishes are available from Aqua Mix, Inc. of Corona, Calif. The concrete mix can have any suitable composition according to the invention, including the specific examples described hereinafter.

A further form of the invention is shown at 30 in FIG. 3, wherein the memorial object does not incorporate cremation ash in the concrete forming the object, but a cavity or compartment 31 is formed in the object for receiving a container 32 holding cremation ash “A” therein. A suitable cover 33 may be provided over the compartment, if desired, secured by screws or other suitable means (not shown).

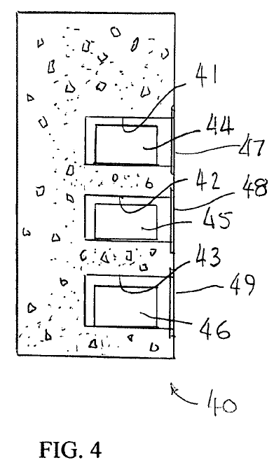

A still further form of the invention is shown at 40 in FIG. 4, wherein the memorial object has multiple compartments 41, 42, 43, etc. formed therein for receiving and storing the cremation ashes 44, 45, 46, etc of multiple persons. Suitable covers such as appropriately inscribed brass plaques 47, 48, 49, etc can be secured over the compartments.

Any of the forms of the invention can have a colorant or stain added to produce a desired appearance, including those from Davis Colors of Los Angeles, Calif., Triple-S Chemical Products, Inc. of California or Scofield Systems of Florida and any can have a protective and/or decorative coating applied.

Although three examples of memorial objects according to the invention are illustrated herein, it should be understood that the object can have any desired shape and size and the invention is not limited to the examples shown.

Following are several examples of compositions or mixes that may be used to make memorial objects according to the invention. It should be understood that the invention is not necessarily limited to these examples, but they have been shown to produce satisfactory results. The values given in the examples are based on an object having a volume of about 1 cubic foot and a weight of from about 110 to about 150 pounds. Cremation remains are not listed in the following examples since they would not be incorporated in that form of the invention that has a cavity for storing the remains in a separate container. However, cremation remains are usually added at the rate of one pound of ash per twenty pounds of the remaining mix, whereby each of the following examples would have about 6 pounds of cremation remains, but the remains may be present in any amount up to about 30 pounds. For instance, the ashes of multiple persons can be mixed in the object. Five pounds of water is initially added to the mix, and then additional water added as necessary to obtain the desired consistency of the mix. The sand is preferably light masonry sand, ranging in color from gray to white, as desired. Various preferred cements can comprise Portland Gray Type I-II, or Portland or Lehigh Type I or III white cement. Type III white cement is preferred because of its finer texture. The color scale for applying color to the memorial object according to the invention is determined based on Portland Gray cement.

### EXAMPLE 1

This example shows a mix for making a memorial object according to the invention wherein reinforcing fibers and a flow enhancer or friction reducer are added.

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |
| Slick Pak⁵ | | 0.3 | oz |
| Glass fibers | | 0.5 | oz |

¹= weighed dry
²= weighed wet
³= Portland Type III white cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer
⁵= a friction reducing flow enhancer sold by Fritz-Pak Corp. of Dallas, Texas - eases flow of the mix into the mold and increases the quality of the finish

### EXAMPLE 2

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |
| Super plasticizer | | 2 | oz⁵ |
| Metakaolin | | 2-3 | lbs |
| Glass fiber | | 0.5-1 | oz |

¹= weighed dry
²= weighed wet
³= Portland Type I white cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer
⁵= ADVA ® 190, a plasticizer sold by Grace Construction Products, Cambridge, Mass.

### EXAMPLE 3

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |
| Daraccel ®⁵ | | 5 | oz |
| ADVA ® 190⁶ | | 2 | oz |

¹= weighed dry
²= weighed wet
³= Portland Type I-II gray cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer
⁵= an accelerator sold by Grace Construction Products, Cambridge, Mass.
⁶= a plasticizer sold by Grace Construction Products, Cambridge, Mass.

### EXAMPLE 4

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |
| Daravair ® 1000⁵ | | 2 | oz |

¹= weighed dry
²= weighed wet
³= Portland Type I-II gray cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer
⁵= an air entraining admixture sold by Grace Construction Products, Cambridge, Mass.

### EXAMPLE 5

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |

¹= weighed dry
²= weighed wet
³= Lehigh Type I white cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer

### EXAMPLE 6

| Ingredient | Volume | Weight | |
|---|---|---|---|
| Sand | 1 five gallon bucket | 50¹-72² | lbs |
| Aggregate | ½ five gallon bucket | 37 | lbs |
| Cement³ | ½ five gallon bucket | 23 | lbs |
| Water | | 5 | lbs⁴ |
| EXP 950⁵ | | 1 | oz |
| Daravair ® 1000⁶ | | 2 | oz |
| Slick Pak⁷ | | 0.3 | oz |
| Glass fibers | | 0.5 to 1 | oz |

¹= weighed dry
²= weighed wet
³= Lehigh Type III white cement
⁴= 5 lbs of water is initially added and additional amounts added at a rate calculated to give a desired consistency, typically at the rate of about 6.5 oz per lb of cement, depending upon ambient conditions and the presence of other additives such as a plasticizer
⁵= a plasticizer sold by Grace Construction Products, Cambridge, Mass.
⁶= an air entraining admixture sold by Grace Construction Products, Cambridge, Mass.
⁷= a plasticizer sold by Fritz-Pak Corp. of Dallas, Texas

It should be noted that suitable results are obtained in each of the examples above when other additives are included in addition to those shown for the particular examples described. That is, in addition to the ingredients shown example 1 could include Metakaolin from example 2, the accelerator from example 3, and/or the air entrainer from example 4. Similar modifications could be made to the other examples.

Although particular embodiments of the invention are illustrated and described in detail herein, it is to be understood that various changes and modifications may be made to the invention without departing from the spirit and intent of the invention as defined by the scope of the appended claims.

1. A memorial object formed of a concrete mix cast in a mold and comprising up to about 50% sand, up to about 25% aggregate, up to about 25% cement, up to about 60% cremation ash of a deceased, and water, wherein the percentage of at least one of sand and aggregate is reduced corresponding to the amount of the cremation ash added.

2. A memorial object as claimed in claim 1, wherein:
a plasticizer is added to the mix to increase flowability.

3. A memorial object as claimed in claim 2, wherein:
the plasticizer comprises a polycarboxylate-based water-reducing admixture.

4. A memorial object as claimed in claim 2, wherein:
the plasticizer comprises one of Metakaolin or fly ash added at the rate of up to about 20% of the amount of cement used in the mix, to improve finish quality and durability.

5. A memorial object as claimed in claim 1, wherein:
an air entrainer is added to the mix to improve freeze-thaw resistance, yield control and finishability performance.

6. A memorial object as claimed in claim 5, wherein:
the air entrainer comprises a liquid admixture that provides freeze-thaw resistance, yield control and finishability performance across the full range of concrete mix designs, for use where the purposeful entrainment of air is required by concrete specifications.

7. A memorial object as claimed in claim 1, wherein:
an accelerator is added to the mix to shorten setting time.

8. A memorial object as claimed in claim 7, wherein:
the accelerator comprises a liquid calcium chloride containing admixture formulated to provide faster set acceleration and increased early strength development of concrete, for use in non-metal molds.

9. A memorial object as claimed in claim 8, wherein:
the accelerator comprises a non-corrosive, non-chloride admixture for concrete that accelerates cement hydration, resulting in shortened setting times and increased early compressive and flexural strengths, for use in metal containing molds or mixes containing metal.

10. A memorial object as claimed in claim 1, wherein:
at least one of Metakaolin and fly ash is added to the mix to increase finish quality and durability.

11. A memorial object as claimed in claim 1, wherein:
glass fibers are added to the mix to increase strength and durability.

12. A memorial object as claimed in claim 1, wherein:
the concrete mix contains at least one of a plasticizer, an accelerator, an air entrainer, and glass fibers.

13. A memorial object as claimed in claim 1, wherein:
the concrete mix contains a plasticizer, an accelerator, an air entrainer, and glass fibers.

14. A memorial object as claimed in claim 1, wherein:
an illumination device is mounted in the memorial object to illuminate the object and surrounding area.

15. A memorial object as claimed in claim 14, wherein:
a motion detector is connected with the illumination device to activate it when someone approaches the memorial object.

16. A memorial object as claimed in claim 1, wherein:
a voice-activated recording is mounted in the memorial object to produce a pre-recorded message when someone approaches the object.

17. A memorial object as claimed in claim 1, wherein:
the memorial object comprises a fountain.

18. A memorial object as claimed in claim 1, wherein:
the memorial object comprises a pedestal.

19. (canceled)

20. (canceled)
